(19) United States
(12) Patent Application Publication
(10) Pub. No.: US 2011/0200888 A1
(43) Pub. Date: Aug. 18, 2011

(54) NON-AQUEOUS ELECTROLYTE SECONDARY BATTERY

(76) Inventors: Yoshiyuki Ozaki, Osaka (JP); Shinji Kasamatsu, Osaka (JP); Hideharu Sato, Tokyo (JP); Shunsuke Yamada, Ibaraki (JP)

(21) Appl. No.: 13/125,242

(22) PCT Filed: Aug. 3, 2010
(86) PCT No.: PCT/JP2010/004879

§ 371 Date: Apr. 20, 2011

(30) Foreign Application Priority Data
Aug. 5, 2009 (JP) 2009-182284

(51) Int. Cl. H01M 10/056; H01M 4/133

(52) U.S. Cl. 429/338

(57) ABSTRACT

An object is to provide a high capacity non-aqueous electrolyte secondary battery in which decomposition of propylene carbonate is suppressed. The non-aqueous electrolyte secondary battery includes: a negative electrode including graphite particles as a negative electrode active material; a positive electrode; a separator; and a non-aqueous electrolyte including propylene carbonate as a non-aqueous solvent. Each of the graphite particles has a surface portion including an amorphous region and a crystal region which includes a plurality of carbon hexagonal net planes stacked along a surface of the graphite particle. Ends of the stacked carbon hexagonal net planes form loops exposed on the surface of the graphite particle. At least a part of the loops are stacked, and the average number of the loops stacked is more than 1 and not more than 2.

### TECHNICAL FIELD

This invention relates to non-aqueous electrolyte secondary batteries. More particularly, it relates to an improvement in a negative electrode active material for a non-aqueous electrolyte secondary battery.

### BACKGROUND ART

The non-aqueous electrolyte used in lithium ion batteries includes a non-aqueous solvent and a solute dissolved in the non-aqueous solvent. As the non-aqueous solvent, carbonate solvents such as propylene carbonate (PC) and ethylene carbonate (EC) are widely used. EC is inactive with respect to graphite-based negative electrode active materials and electrochemically stable in a wide oxidation-reduction potential range, so it is advantageously used as a medium for charge/discharge reactions. However, since EC has a high melting point and is solid at room temperature, it cannot be used singly. PC has a high dielectric constant, a low melting point, and relative electrochemical stability in a wide oxidation-reduction potential range, so it is advantageously used as a non-aqueous solvent. However, when a highly crystalline graphite-based negative electrode active material is used, PC is decomposed on the surface of the graphite-based negative electrode active material during charge, thereby causing the battery case to swell due to gas production.

A common graphite particle has a plurality of carbon hexagonal net planes which are stacked in layers. Edge planes, each of which comprises edges of the carbon hexagonal net planes, are exposed on the particle surface. Each edge plane exposed on the particle surface has gaps between the adjacent carbon hexagonal net planes. Through the gaps, lithium ions are absorbed or released.

PC is decomposed during charge in the gaps in the edge planes of the carbon hexagonal net planes. To suppress decomposition of PC by the graphite-based negative electrode active material, proposals have been made to improve graphite-based negative electrode active materials. For example, PTL 1 discloses graphite particles comprising natural flake graphite particles with a water-soluble polymer adsorbed or coated onto the surface thereof, the water-soluble polymer being composed basically of polyuronide. Such decomposition of PC is suppressed by coating the active sites of PC decomposition on the natural graphite particle surface with the water-soluble polymer. Also, PTL 2 discloses a graphite-based negative electrode active material comprising a crystalline carbon core material with an amorphous carbon layer formed on the surface thereof. Such decomposition of PC is suppressed by coating the surface of the highly active, crystalline carbon material with the inactive amorphous carbon layer. Also, PTL 3 discloses a relatively low crystalline, graphitizable carbon material having a predetermined X-ray diffraction pattern and a crystallite thickness in the direction of the C axis of 20 to 60 nm. Also, PTL 4 discloses a graphite powder having a surface structure in which closed parts 16 are scattered on the powder surface, as illustrated in FIG. 6. Each of the closed parts comprises graphite c plane layers whose ends (edge plane) are joined to form a closed loop, extends in the direction perpendicular to the carbon hexagonal net planes, and has a length in the direction perpendicular to the graphite c axis of 100 nm or less.
[PTL 1] Japanese Laid-Open Patent Publication No. 2002-231241
[PTL 2] Japanese Laid-Open Patent Publication No. Hei 11-31499
[PTL 3] Japanese Laid-Open Patent Publication No. 2007-103246
[PTL 4] Japanese Laid-Open Patent Publication No. 2002-75362

### SUMMARY OF INVENTION

### Problem to be Solved by the Invention

The graphite particles disclosed by PTL 1 have a problem in that the polymer coating the particle surface lowers the charge/discharge characteristics at high rates. Also, when the polymer on the surface becomes separated by rolling for negative electrode production or repeated charge/discharge, the effect of suppressing decomposition of PC may be impaired. In the case of the carbon material disclosed in PTL 2, the amorphous carbon layer on the surface may also become separated by rolling for negative electrode production or repeated charge/discharge, thereby impairing the effect of suppressing decomposition of PC. Also, the graphitizable carbon material disclosed in PTL 3 has a relatively low crystallinity, thereby making it difficult to heighten the battery capacity sufficiently in some cases.

Also, the graphite particles disclosed by PTL 4 have, on the surface, the closed parts 16 which are formed by joining the ends of a plurality of carbon hexagonal net planes by a heat treatment and each of which typically consists of about 3 to 7 layers, as illustrated in FIG. 6. The gaps between the carbon hexagonal net planes in the edge planes exposed on the particle surface are decreased by forming the closed parts 16. However, PC seemed to be decomposed also in gaps 18 between the adjacent closed parts 16. If the number of the gaps 18 exposed on the particle surface is too large, decomposition of PC cannot be sufficiently suppressed.

The invention relates to a high capacity non-aqueous electrolyte secondary battery including graphite particles as a negative electrode active material and PC as a non-aqueous solvent, and intends to suppress the battery from swelling with the gas produced by decomposition of PC.

### Solution to Problem

One aspect of the invention is a non-aqueous electrolyte secondary battery comprising: a negative electrode including graphite particles as a negative electrode active material; a positive electrode; a separator; and a non-aqueous electrolyte including propylene carbonate as a non-aqueous solvent. Each of the graphite particles has a surface portion including an amorphous region and a crystal region which includes a plurality of carbon hexagonal net planes stacked along a surface of the graphite particle. Ends of the stacked carbon hexagonal net planes form loops exposed on the surface of the graphite particle. At least a part of the loops are stacked, and the average number of the loops stacked is more than 1 and not more than 2.

The graphite particles included in the non-aqueous electrolyte secondary battery have a surface portion including an amorphous region and a crystal region having a plurality of carbon hexagonal net planes aligned along the graphite particle surface. The crystal region includes a plurality of carbon hexagonal net planes aligned along the graphite particle surface, and ends of the carbon hexagonal net planes form loops. The loops are exposed on the graphite particle surface. At least a part of the loops are stacked to form a stack of the loops, and the average number of the loops stacked is more than 1 and not more than 2. Through the gap between the stacked loops exposed on the surface, lithium ions are absorbed or released into or from the interior of the highly crystalline graphite particle. Thus, a large discharge capacity can be obtained. Also, the average number of the loops stacked is more than 1 and not more than 2, and this allows decomposition of PC to be suppressed sufficiently. In addition, the surface portion of the graphite particle has an amorphous region. In the amorphous region, decomposition of PC is suppressed.

The graphite particles are preferably spherical flake graphite particles. As a result of the spheronization process of the flake graphite particles, a part of the crystal region of the surface portion of the flake graphite particle is converted to an amorphous region, while the high crystallinity of the interior of the particle is maintained. Also, the amorphous region, which is formed by converting the crystal region of the surface portion of the highly crystalline, unitary flake graphite particle, is resistant to separation. Hence, the amorphous region is not easily separated by rolling or repeated charge/discharge, unlike graphite particles produced by coating an amorphous carbon layer on the surface. Thus, decomposition of PC is suppressed with high reliability.

Preferably, the graphite particles exhibit an electron spin resonance (ESR) spectrum having an asymmetric peak around a magnetic field strength of 3350 gauss, as shown by (a) in FIG. 4. The asymmetric peak preferably has a peak center around 3350 gauss, a shoulder at and around 3300 gauss, is broad and weak at the lower magnetic field than that at the peak center, and is narrow and strong at the higher magnetic field than that at the peak center. Since the graphite particles have the amorphous carbon layer on the particle surface, the existence probability of unpaired electrons decreases, and the peak attributed to the carbon hexagonal net planes on the particle surface become unclear.

In the non-aqueous electrolyte secondary battery, the graphite particles preferably have a bulk density of 0.4 g/cm³ or more and 0.6 g/cm³ or less, a tap density after 1000 taps of 0.85 g/cm³ or more and 0.95 g/cm³ or less, and a BET specific surface area of larger than 5 m²/g and not larger than 6.5 m²/g.

Also, in the graphite particles, the ratio of the rhombohedral region to the total of the hexagonal region and the rhombohedral region is preferably in the range of 21 to 35%, since the reactivity with respect to PC is low and decomposition of PC during charge can be suppressed. Common graphite particles have a layer structure including a rhombohedral structure (3R), in which three layers form one unit, and a hexagonal structure (2H), in which two layers form one unit. In common graphite particles, the ratio of 3R to the total of the rhombohedral region (3R) and the hexagonal region (2H), i.e., [(3R)/((3R)+(2H))×100], is approximately less than 20%. As the above, excessive reaction between the graphite particles and the non-aqueous electrolyte can be suppressed, so decomposition of other non-aqueous solvent than PC and deterioration of solute such as a lithium salt can also be suppressed.

Also, the non-aqueous solvent preferably contains 30 to 60% by weight of propylene carbonate.

### Effects of Invention

In a high capacity non-aqueous electrolyte secondary battery including graphite particles as a negative electrode active material and PC as a non-aqueous solvent, the invention can suppress swelling of the battery with the gas produced by decomposition of PC.

The objects, features, aspects, and advantages of the invention will become more apparent from the detailed description below and appended drawings.

### BRIEF DESCRIPTION OF DRAWINGS

FIG. 1 is a schematic view of the appearance of graphite particles included in the negative electrode of a non-aqueous electrolyte secondary battery;

FIG. 2 is a schematic sectional view of a surface portion of the graphite particle in an Embodiment;

FIG. 3 is a transmission electron microscope (TEM) photo of a section of a graphite particle of Example 1;

FIG. 4 shows ESR spectra of graphite particles, wherein (a) is the spectrum of a graphite particle used in an Example, (b) is the spectrum of a conventional graphite particle, and (c) is the spectrum of a graphite particle whose surface is coated with amorphous carbon;

FIG. 5 is a partially cut-out front view of a non-aqueous electrolyte secondary battery in an Embodiment;

FIG. 6 is a schematic sectional view of a surface portion of a graphite particle included in a conventional non-aqueous electrolyte secondary battery; and

FIG. 7 is a TEM photo of a section of multilayer graphite in Comparative Example 2.

### DESCRIPTION OF EMBODIMENTS

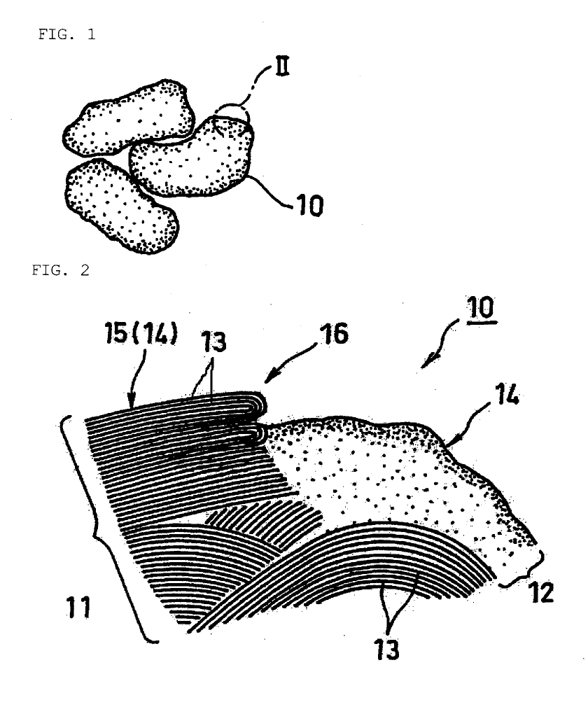

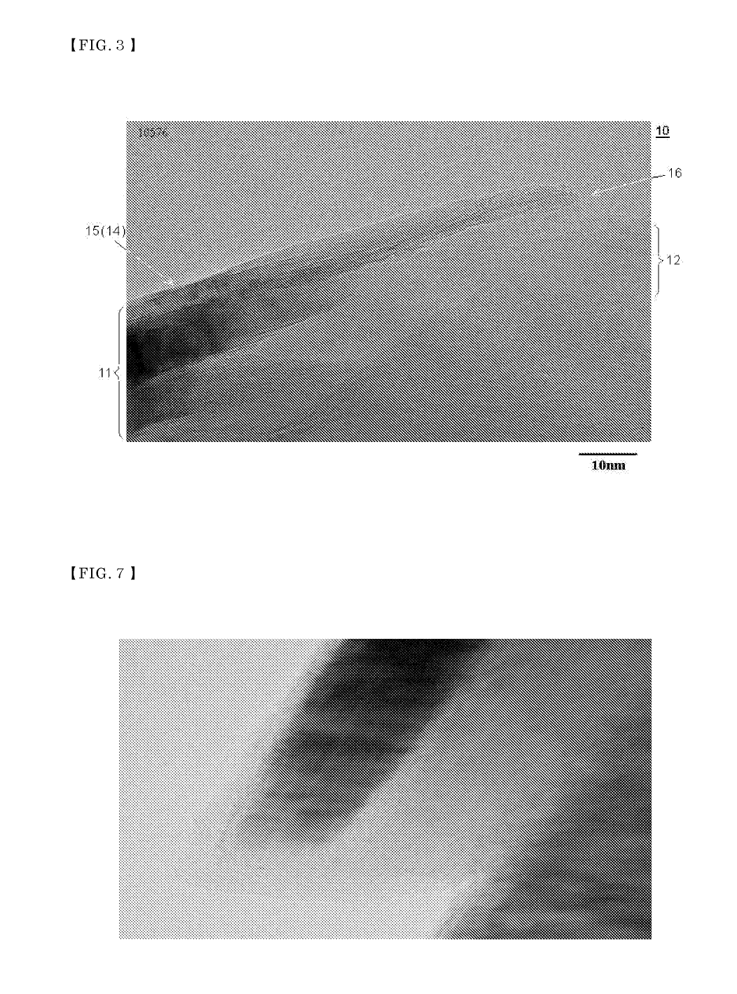

Graphite particles 10 used as a negative electrode active material in a non-aqueous electrolyte secondary battery of this embodiment are described with reference to FIG. 1 and FIG. 2. FIG. 1 is a schematic view of the appearance of the graphite particles 10, and FIG. 2 is a schematic, enlarged sectional view of the surface portion of the graphite particle 10 shown by II in FIG. 1.

As illustrated in FIG. 2, the graphite particle 10 is a particle having a crystal region 11 and an amorphous region 12 in the particle surface portion. Also, exposed on a particle surface 14 over a relatively large area are carbon hexagonal net planes 13, which are aligned along the graphite particle surface to form basal planes 15. Since the carbon hexagonal net planes 13 are exposed on the particle surface 14, decomposition of PC is suppressed.

The crystal region 11 exposed on the particle surface 14 has loops (closed parts) 16, each of which is formed by joining the ends of the carbon hexagonal net planes 13 into the shape of a loop. In each of the loops 16, the gaps between the adjacent carbon hexagonal net planes 13 are closed. Thus, decomposition of PC is unlikely to occur in the loops 16. At least a part of the loops 16 are stacked to form a stack as illustrated in FIG. 2. The number of the loops 16 stacked is usually 1 or 2 in the direction of c axis of the carbon hexagonal net planes 13. Also, the average number of the loops stacked is typically more than 1 and not more than 2.

There is a gap between the adjacent loops 16 stacked. From the gap, lithium ions are adsorbed or released into or from the highly crystalline graphite inside the graphite particle 10. PC is decomposed in the gap between the adjacent loops 16. However, since the number of gaps between the loops 16 exposed on the particle surface 14 is very small, decomposition of PC on the particle surface can be significantly suppressed, while lithium ions can be adsorbed or released into or from the highly crystalline graphite inside the graphite particle 10.

The graphite particles 10 can be produced by, for example, subjecting flake graphite particles to a spheronization process. Specifically, for example, flake graphite particles are introduced into a spheronizer, in which they are crushed and classified a plurality of times to make them spherical. Since the flake graphite particles are made spherical in this manner, the resulting graphite particles 10 have a structure in which the carbon hexagonal net planes 13 are bent and stacked in the particle. The particles having the amorphous region 12 in the particle surface portion produced by such spheronization process of the flake graphite particles is a unitary particle in which the crystal region 11 and the amorphous region 12 are integrated, which is produced by making the carbon hexagonal net planes 13 amorphous through the spheronization process of the flake graphite particles. That is, the graphite particles 10 do not have a multilayer structure obtained by, for example, coating the surface of graphite particles with an amorphous layer. Therefore, the amorphous region 12 does not become separated from the graphite particles 10 even when the negative electrode including the graphite particles 10 is subjected to rolling or repeated charge/discharge. Also, there is no such problem as separation of the amorphous region 12 resulting in more gaps between the carbon hexagonal net planes 13 on the particle surface and increased reactivity with respect to PC with time.

The volume-basis mean particle size D50 of the graphite particles is preferably 25 μm or less, and more preferably in the range of 23 to 19 μm. When the mean particle size D050 is in this range, the dispersion of the graphite particles in the negative electrode is improved, and a decrease in the capacity of the negative electrode tends to be suppressed.

The bulk density of the graphite particles is preferably 0.4 g/cm³ or more and 0.6 g/cm³ or less, and more preferably, 0.45 g/cm³ or more and 0.55 g/cm³ or less. If the bulk density is too low, application properties for negative electrode production tend to deteriorate. Also, if the bulk density is too high, the dispersion of the graphite particles in the negative electrode becomes poor, so the capacity of the negative electrode tends to decrease.

Further, the tap density of the graphite particles after 1000 taps is preferably 0.85 g/cm³ or more and 0.95 g/cm³ or less, and more preferably 0.88 g/cm³ or more and 0.93 g/cm³ or less. If the tap density is too low, application properties for negative electrode production tend to deteriorate. If the tap density is too high, the dispersion of the graphite particles in the negative electrode becomes poor, so the capacity of the negative electrode tends to decrease.

Also, the BET specific surface area of the graphite particles determined based on the amount of N₂ adsorption is preferably larger than 5 m²/g and not larger than 6.5 m²/g, and more preferably 5.2 m²/g or more and 6.2 m²/g or less. If the BET specific surface area is too low, the adsorption of Li during charge tends to become difficult (Li acceptance tends to decrease). Also, if the BET specific surface area is too high, the reactivity with the non-aqueous electrolyte increases, and gas production tends to occur.

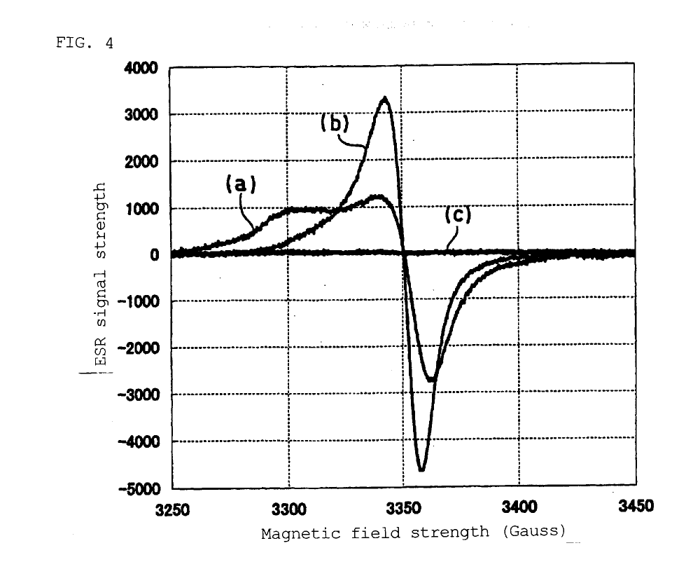

Also, the graphite particles preferably have an ESR spectrum having an asymmetric peak around a magnetic field strength of 3350 gauss, as shown by, for example, (a) in FIG. 4. More preferably, the asymmetric peak has a peak center around 3350 gauss and a shoulder at and around 3300 gauss, is broad and weak at the lower magnetic field than that at the peak center, and is narrow and strong at the higher magnetic field than that at the peak center.

ESR spectra reflect the electron state on the particle surface. In the case of a common graphite particle having a structure in which the basal plane and the edge plane are clearly divided, the signal strength of ESR is significantly strong, as shown by, for example, (b) in FIG. 4, since unpaired electrons of the basal plane resonate in the magnetic field. In the case of multilayer graphite as used in Comparative Example 2 below, as shown by, for example, (c) in FIG. 4, almost no signal appears since the particle surface is coated with an amorphous carbon layer. On the other hand, the ESR spectrum of the graphite particle of this embodiment has an asymmetric peak at and around a magnetic field strength of 3350 gauss. This peak is broad and weak at the lower magnetic field than that at the peak center, and is narrow and strong at the higher magnetic field than that at the peak center. Further, this peak has a shoulder peak in a region (approximately 3300 gauss) in which the magnetic field strength is lower than the peak center of approximately 3350 gauss. This shoulder peak can be ascribed to a large number of unpaired electrons which remain between the basal planes in the graphite particle to cause resonance.

In the X-ray diffraction pattern of graphite particles, four peaks appear in a Bragg angle (2θ) range of 40° to 50°. The peak around 2θ of 42.3° and the peak around 44.4° are diffraction patterns attributed to the (100) face and the (101) face of the hexagonal (2H) structure, respectively. The peak around 20 of 43.3° and the peak around 46.0° are diffraction patterns attributed to the (101) face and the (012) face of the rhombohedral (3R) structure, respectively. From the ratio of the integrated peak intensities, the ratio between the 2H structure and the 3R structure in the crystal region of the graphite particle can be determined.

In the graphite particles in this embodiment, the ratio of 3R to the total of the rhombohedral region (3R) and the hexagonal region (2H), i.e., ([(3R)/((3R)+(2H))×100]), is preferably 21% or more and 35% or less, and more preferably 25% or more and 31% or less. If this ratio is too low, the effect of suppressing decomposition of PC tends to decrease. Also, if the ratio is too high, the graphite particles and the non-aqueous electrolyte react excessively, so decomposition of other non-aqueous solvent than PC and deterioration of solute such as a lithium salt tend to occur.

The non-aqueous electrolyte secondary battery of this embodiment using the above-described graphite particles is hereinafter described.

The non-aqueous electrolyte secondary battery of this embodiment includes a negative electrode containing the above-described graphite particles as a negative electrode active material, a positive electrode, a separator, and a non-aqueous electrolyte containing propylene carbonate as a non-aqueous solvent.

The negative electrode can be produced by, for example, forming a negative electrode active material layer which contains the above-described graphite particles as the negative electrode active material on a surface of a negative electrode current collector. The negative electrode current collector is preferably a copper foil such as an electrolytic copper foil or a metal foil such as a copper alloy foil. The copper foil may contain other components than copper in an amount of, for example, 0.2 mol % or less.

The negative electrode active material layer is formed on a surface of a negative electrode current collector by, for example, applying a negative electrode mixture slurry which is prepared by dispersing the above-described graphite particles in a suitable dispersion medium onto the surface of the negative electrode current collector, drying it, and rolling it.

The dispersion medium used to prepare the negative electrode mixture slurry is water, alcohol, N-methyl-2-pyrrolidone, or the like. It is preferably water.

The negative electrode mixture slurry may contain a binder, a water-soluble polymer, etc., if necessary. Preferable examples of binders are polymers having a styrene unit or a butadiene unit in the molecule as a repeating unit, such as styrene-butadiene rubber. Also, examples of water-soluble polymers include cellulose such as carboxymethyl cellulose, polyacrylic acid, polyvinyl alcohol, polyvinyl pyrrolidone, and derivatives thereof. The amount of the water-soluble polymer contained in the negative electrode active material layer is preferably 0.5 to 2.5 parts by weight per 100 parts by weight of the graphite particles, and more preferably 0.5 to 1.5 parts by weight.

After the negative electrode mixture slurry is applied onto the surface of the negative electrode current collector, it is dried and rolled, so that a negative electrode active material layer is formed on the surface of the negative electrode current collector.

The positive electrode is produced by, for example, forming a positive electrode active material layer containing various positive electrode active materials used in non-aqueous electrolyte secondary batteries on a surface of a positive electrode current collector. As examples of the positive electrode current collector, materials conventionally used as positive electrode current collectors, such as metal foils made of stainless steel, aluminum, or titanium, can be used without any particular limitation.

Examples of positive electrode active materials include lithium-containing transition metal composite oxides. Examples of lithium-containing transition metal composite oxides include LiCoO₂, LiNiO₂, LiMn₂O₄, LiMnO₂, LiₓNi_{y}M_{z}Me_{1-(y+z)}O_{2+d} where M is at least one of Co and Mn, Me is at least one of Al, Cr, Fe, Mg, and Zn, 0.98≦x≦1.10, 0.3≦y≦1.0, 0≦z≦0.7, 0.9≦(y+z)≦1.0, and −0.01≦d≦0.01.

The positive electrode active material layer can be formed on a surface of a positive electrode current collector by, for example, applying a positive electrode mixture slurry which is prepared by dispersing a positive electrode active material, a conductive agent such as carbon black, and a binder such as polyvinylidene fluoride in a suitable dispersion medium onto the surface of the positive electrode current collector, drying it, and rolling it.

An example of the separator is a microporous film having a thickness of approximately 10 to 30 μm and being made of polyethylene, polypropylene, etc.

The non-aqueous electrolyte contained in the non-aqueous electrolyte secondary battery of this embodiment includes a lithium salt, a non-aqueous solvent containing propylene carbonate, and can be prepared by dissolving the lithium salt in the non-aqueous solvent.

Examples of other non-aqueous solvents than propylene carbonate include aprotic organic solvents: cyclic carbonic acid esters such as ethylene carbonate and butylene carbonate; chain carbonic acid esters such as dimethyl carbonate (DMC), ethyl methyl carbonate (EMC), and diethyl carbonate; cyclic ethers such as tetrahydrofuran and 1,3-dioxolane; chain ethers such as 1,2-dimethoxyethane and 1,2-diethoxyethane (DEE); cyclic carboxylic acid esters such as γ-butyrolactone and γ-valerolactone; and chain esters such as methyl acetate. The other non-aqueous solvents than propylene carbonate may be used singly or in combination. The non-aqueous solvent is preferably a solvent mixture of a cyclic carbonic acid ester and a chain carbonic acid ester, in particular, a solvent mixture of PC, EC, and DEC.

While the content of propylene carbonate in the non-aqueous solvent is not particularly limited, it is preferably in the range of 30 to 60% by weight in terms of suppressing production of gas.

Examples of lithium salts include LiBF₄, LiClO₄, LiPF₆, LiSbF₆, LiAsF₆, LiAlCl₄, LiCF₃SO₃, LiCF₃CO₂, LiSCN, lithium lower aliphatic carboxylates, LiBCl, LiB₁₀Cl₁₀, lithium halides such as LiCl, LiBr, and LiI, borates such as lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate, and imide salts such as LiN(CF₃SO₂)₂, LiN(CF₃SO₂)(C₄F₉SO₂) and LiN(C₂F₅SO₂)₂). These lithium salts can be used singly or in combination.

The non-aqueous electrolyte secondary battery of this embodiment is applicable to various shapes such as prismatic, cylindrical, flat, and coin shapes, and the battery shape is not particularly limited. In the non-aqueous electrolyte secondary battery of this embodiment, swelling of the battery case with the gas produced by decomposition of PC is effectively suppressed. In particular, the non-aqueous electrolyte secondary battery of this embodiment is more effective in suppressing swelling of prismatic batteries which tend to swell.

The invention is more specifically described by way of Examples. The scope of the invention is not to be construed as being limited in any way to the following Examples.

### EXAMPLES

### Example 1

### (1) Preparation of Graphite Particles

Graphite particles A were prepared by introducing natural flake graphite with a volume-basis mean particle size (D50) of 100 μm or more into a spheronizer, and crushing and classifying them a plurality of times. The graphite particles A had a volume-basis mean particle size (D50) of 19 μm, a bulk density of 0.49 g/cm³, a tap density after 1000 taps of 0.90 g/cm³, and a specific surface area by the BET method (N₂ adsorption) of 5.4 m²/g. FIG. 3 shows a representative TEM photo of a section of the graphite particle A. As shown by the TEM photo of FIG. 3, a particle surface 14 of the graphite particle A had an amorphous region 12 and a crystal region 11 including a plurality of carbon hexagonal net planes 13 stacked along the particle surface 14 of the graphite particle A. Also, the ends of the stacked carbon hexagonal net planes 13 form two loops 16 stacked. Other TEM photos also showed one or two loops 16 stacked. The ESR spectrum is shown by (a) in FIG. 4. The ESR spectrum of the graphite particle A had an asymmetric peak around a magnetic field strength of 3350 gauss and a shoulder at and around 3300 gauss, was broad and weak at the lower magnetic field than that at the peak center, and was narrow and strong at the higher magnetic field than that at the peak center.

Also, the X-ray diffraction spectrum of the graphite particles A obtained was measured. The measurement was made using CuKα radiation which was made monochromatic by a graphite monochrometer under the conditions of an output of 30 kV (200 mA), a divergence slit of 0.5°, a receiving slit of 0.2 mm, and a scattering slit of 0.5°. The ratio of 3R to the total of the rhombohedral region (3R) and the hexagonal region (2H), i.e., [(3R)/((3R)+(2H))×100], was calculated and found to be 29%.

### (2) Preparation of Negative Electrode

A carboxymethyl cellulose (CMC) aqueous solution with a concentration of 1 wt % by weight was prepared. Then, 100 parts by weight of the graphite particles A and 100 parts by weight of the CMC aqueous solution were mixed, and stirred while the temperature of the mixture was kept at 25° C. Subsequently, the mixture was dried at 120° C. for 5 hours to obtain a dry mixture. The content of CMC in the dry mixture per 100 parts by weight of the graphite particles was 1.0 part by weight.

Next, 101 parts by weight of the dry mixture, 0.6 part by weight of styrene-butadiene rubber latex (SBR latex), 0.9 part by weight of CMC, and a suitable amount of water were mixed to prepare a negative electrode mixture slurry. The SBR latex had a rubber particle mean particle size of 0.12 μm and a solid content of 40% by weight.

The negative electrode mixture slurry was applied onto both sides of an electrolytic copper foil (thickness 12 μm) with a die coater, and the resultant coating films were dried at 120° C. The dried coating films were rolled with rollers at a linear load of 0.25 ton/cm to form negative electrode active material layers with a thickness of 160 μm and an active material density of 1.65 g/cm³. The negative electrode current collector with the negative electrode active material layers was cut to a predetermined shape to obtain a negative electrode.

### (3) Preparation of Positive Electrode

LiNi_{0.80}CO_{0.15}Al_{0.05}O₂ was used as a positive electrode active material. A positive electrode mixture slurry was prepared by mixing 100 parts by weight of the positive electrode active material, 4 parts by weight of polyvinylidene fluoride, and a suitable amount of N-methyl-2-pyrrolidone. The positive electrode mixture slurry was applied onto both sides of an aluminum foil (thickness 20 μm) with a die coater, and the resultant coating films were dried. The coating films were rolled to form positive electrode active material layers. The positive electrode current collector with the positive electrode active material layers was cut to a predetermined shape to obtain a positive electrode.

### (4) Preparation of Non-Aqueous Electrolyte

EC, PC, and DEC were mixed at a weight ratio of 1:5:4. LiPF₆ was dissolved in the resultant solvent mixture at a concentration of 1 mol/L to obtain a non-aqueous electrolyte.

### (5) Fabrication of Battery

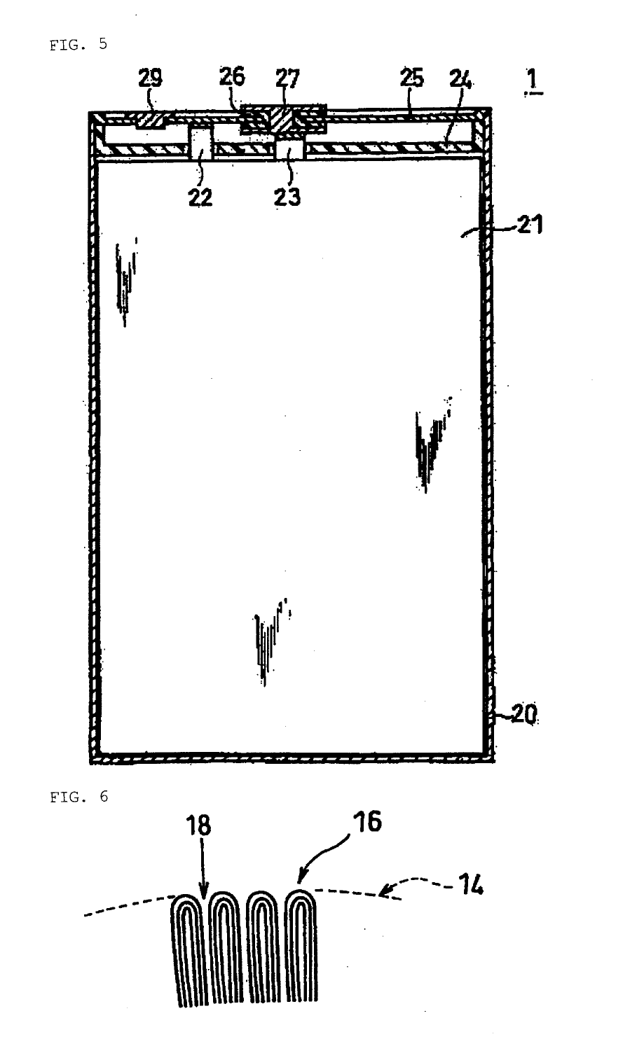

A prismatic lithium ion battery 1 as illustrated in FIG. 5 was produced. Specifically, the negative electrode and the positive electrode were wound with a separator comprising a 20-μm thick microporous polyethylene film (A089 (trade name) available from Celgard K.K.) interposed therebetween, to produce an electrode assembly 21 having a substantially oval section. The electrode assembly 21 was placed in a prismatic battery can 20 made of aluminum. The battery can 20 has a bottom, side walls, and an open top, and its cross-section has a substantially rectangular shape. The flat portions of the side walls were 80 μm in thickness.

Next, an insulating member 24 for preventing a short circuit between the battery can 20 and a positive electrode lead 22 or a negative electrode lead 23 was mounted on top of the electrode assembly 21. A rectangular seal plate 25, having, at its center, a negative electrode terminal 27 surrounded by an insulating gasket 26, was fitted to the opening of the battery can 20. The negative electrode lead 23 was connected to the negative electrode terminal 27. The positive electrode lead 22 was connected to the lower face of the seal plate 25. The seal plate 25 was insulated from the negative electrode terminal 27 by the insulating gasket 26. The edge of the opening and the seal plate 25 were laser welded to seal the opening of the battery can 20. From the injection hole of the seal plate 25, 2.5 g of the non-aqueous electrolyte was injected in the battery can 20. The injection hole was then closed with a seal stopper 29 by welding. In this manner, the prismatic lithium ion battery (hereinafter referred to as simply the battery) 1 was produced which had a height of 50 mm, a width of 34 mm, an inner space thickness of approximately 5.2 mm, and a design capacity of 850 mAh.

### (6) Evaluation of Battery

### (i) Evaluation of Cycle Capacity Retention Rate

The battery 1 was subjected to charge/discharge cycles at 45° C. under the following cycle conditions. In each cycle, a constant-current charge and a constant-voltage charge were performed at a maximum current of 600 mA and an upper limit voltage of 4.2 V for two and a half hours. After the charge, a-10-minute break was made. Then, a constant current discharge was performed at a discharge current of 850 mA and an end-of-discharge voltage of 2.5 V. After the discharge, a 10-minute break was made. The percentage of the discharge capacity at the 500^{th} cycle relative to the discharge capacity at the 3^{rd} cycle, which was defined as 100%, was used as the cycle capacity retention rate [%]. The result is shown in Table 1.

### (ii) Evaluation of Battery Swelling

The thickness of the battery 1 near the center of the side walls was measured after the charge at the 3^{rd} cycle and the charge at the 501^{st} cycle. The difference [mm] between the battery thickness after the charge at the 3^{rd} cycle and that after the charge at the 501^{st} cycle was obtained. The result is shown in Table 1.

### Comparative Example 1

A negative electrode was prepared in the same manner as in Example 1, except that natural flake graphite particles B with a volume-basis mean particle size D50 of 16 μm were used as a negative electrode active material without being subjected to a spheronization process. Using this negative electrode, a battery was produced and evaluated in the same manner as in Example 1. The results are shown in Table 1.

The natural flake graphite B had a bulk density of 0.35 g/cm³, a tap density after 1000 taps of 0.8 g/cm³, and a BET specific surface area of 6.8 m²/g. The ESR spectrum of the natural flake graphite particle B is shown by (b) in FIG. 4. Also, the X-ray diffraction spectrum of the natural flake graphite particle B was measured, and the ratio of 3R to the total of 3R and 2H was calculated. The 3R ratio of the natural flake graphite particle B was 12%, and the interior of the particle and the surface portion both had high crystallinity with almost no amorphous region.

### Comparative Example 2

Using a kneader, 100 parts by weight of the natural flake graphite particles B used in Comparative Example 1 and 10 parts by weight of isotropic coal pitch were kneaded. The resulting mixture was heat-treated at 1300° C. in an argon atmosphere to carbonize the isotropic coal pitch. In this manner, multilayer graphite C comprising the natural flake graphite particles B with an amorphous carbon layer on the surface was produced. Using the multilayer graphite C as the negative electrode active material, a negative electrode was prepared in the same manner as in Example 1. Using the negative electrode, a battery was produced and evaluated in the same manner as in Example 1. The results are shown in Table 1.

The multilayer graphite C had a bulk density of 0.70 g/cm³, a tap density after 1000 taps of 1.2 g/cm³, and a BET specific surface area of 2.7 m²/g. Also, the X-ray diffraction spectrum of the multilayer graphite C was measured, and the ratio of 3R to the total of 3R and 2H was 16%. Also, the TEM photo of a section of the multilayer graphite C is shown in FIG. 7. The TEM photo of FIG. 7 indicates that the multilayer graphite C is highly crystalline in the interior of the particle, with the surface portion being coated with the amorphous region. Also, the ESR spectrum of the multilayer graphite C is shown by (c) in FIG. 4. In the ESR spectrum (c) in FIG. 4, the ESR signal strength was not observed since the particle surface portion is almost completely an amorphous region and the electron state of the amorphous region was reflected.

TABLE 1

| | Cycle capacity | Amount of battery |
|---|---|---|
| | retention rate [%] | swelling [mm] |
| Example 1 | 81 | 0.3 |
| Comp. Example 1 | (Unable to | 1.5 |
| | charge/discharge) | |
| Comp. Example 2 | 69 | 0.8 |

As is clear from Table 1, the battery of Example 1 exhibited a high cycle capacity retention rate and very little battery swelling. On the other hand, in the case of Comparative Example 1, after one charge/discharge cycle, the battery swelled significantly so it was unable to charge/discharge thereafter. Specifically, the battery swelled as much as 1.5 mm after one charge/discharge cycle. The battery of Comparative Example 2 had a low cycle capacity retention rate, compared with Example 1. The amount of battery swelling was suppressed to some extent, but was still large, compared with the amount of swelling in Example 1.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The non-aqueous electrolyte secondary battery of the invention is useful as a non-aqueous electrolyte secondary battery such as a lithium ion battery.

### REFERENCE SIGNS LIST

1 Prismatic Lithium Ion Battery, 10 Graphite Particle, 11 Crystal Region, 12 Amorphous Region, 13 Carbon Hexagonal Net Plane, 14 Particle Surface, 15 Basal Plane, 16 Closed Part, 18 Gap, 20 Battery Can, 21 Electrode Assembly, 22 Positive Electrode Lead, 23 Negative Electrode Lead, 24 Insulating Member, 25 Seal Plate, 26 Insulating Gasket, 27 Negative Electrode Terminal, 29 Seal Stopper

1. A non-aqueous electrolyte secondary battery comprising: a negative electrode including graphite particles as a negative electrode active material; a positive electrode; a separator; and a non-aqueous electrolyte including propylene carbonate as a non-aqueous solvent,
wherein each of the graphite particles has a surface portion including an amorphous region and a crystal region which includes a plurality of carbon hexagonal net planes stacked along a surface of the graphite particle,
ends of the stacked carbon hexagonal net planes form loops exposed on the surface of the graphite particle,
at least a part of the loops are stacked, and
the average number of the loops stacked is more than 1 and not more than 2.

2. The non-aqueous electrolyte secondary battery in accordance with claim 1, wherein the graphite particles are spherical graphite particles made from flake graphite particles.

3. The non-aqueous electrolyte secondary battery in accordance with claim 1, wherein the graphite particles exhibit an electron spin resonance spectrum having an asymmetric peak around a magnetic field strength of 3350 gauss.

4. The non-aqueous electrolyte secondary battery in accordance with claim 3, wherein the asymmetric peak has a peak center around a magnetic field strength of 3350 gauss, a shoulder around a magnetic field strength of 3300 gauss, is broad and weak at a lower magnetic field than that at the peak center, and is narrow and strong at a higher magnetic field than that at the peak center.

5. The non-aqueous electrolyte secondary battery in accordance with claim 1, wherein the graphite particles have a bulk density of 0.4 g/cm³ or more and 0.6 g/cm³ or less, a tap density after 1000 taps of 0.85 g/cm³ or more and 0.95 g/cm³ or less, and a BET specific surface area of larger than 5 m²/g and not larger than 6.5 m²/g.

6. The non-aqueous electrolyte secondary battery in accordance with claim 1, wherein the graphite particles have a hexagonal region and a rhombohedral region, and the ratio of the rhombohedral region to the total of the hexagonal region and the rhombohedral region is in the range of 21 to 35%.

7. The non-aqueous electrolyte secondary battery in accordance with claim 1, wherein the non-aqueous solvent contains 30 to 60% by weight of the propylene carbonate.
